(19) United States
(12) Patent Application Publication
(10) Pub. No.: US 2005/0193587 A1
(43) Pub. Date: Sep. 8, 2005

(54) DRYING PROCESS FOR WAFERS

(76) Inventors: Chien-Hua Tsai, Tai-Chung City (TW); Yi-Chin WU, Kao-Hsiung City (TW); Yen-Shen WEI, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,429

(22) Filed: Mar. 3, 2004

(51) Int. Cl. F26B 3/00; F26B 5/04

(52) U.S. Cl. 34/351; 34/467

(57) ABSTRACT

A drying process for wafers includes positioning the wafers to be dried in a cleaning device full of isopropyl alcohol (IPA) vapor and replacing moisture out of the wafers with the IPA vapor. Gas steam including the IPA vapor is exhausted from the cleaning device into a scrubber, and the scrubber has at least a solvent therein for dissolving the IPA vapor and an exhaust outlet for discharging gas mixture of the IPA vapor and the solvent. A flow rate of the solvent in the scrubber is adjusted to increase a concentration of the IPA vapor in the cleaning device and thus obtain better uniformity for drying the wafers.

### BACKGROUND OF INVENTION

1. Field of the Invention

The present invention relates to a drying process for wafers, and more particularly, to a drying process to improve drying uniformity on wafers.

2. Description of the Prior Art

During semiconductor fabrication processes, some metal ions, particles and organic compounds may remain on surfaces of wafers. Native oxides may also form on the wafers after cleaning, deposition, etching and conveying processes, degrading the quality of the semiconductor products. One or more cleaning processes are consequently employed to ensure the surface cleanliness of the wafers.

In general, there are two types of cleaning processes: wet and dry. The wet cleaning process is wildly employed. For example, a resistor solvent such as ACT or EKC is often used to remove a resistor from a wafer after photolithographic and etching processes. Following that, cleaning solutions such as N-Methyl-Pyrolidone (NMP) and water are used to rinse the wafer and remove the residual resistor completely. After the wet cleaning procedures as mentioned above are completed, a drying process is performed on the wafer to remove any residual water as quickly as possible. The drying process is used to prevent watermarks and their associated defects from forming on the wafer, and prevent dissolved oxygen(DO) in the water reacts with the bare silicon on the surface of the wafer.

Methods for drying wafers according to the prior art include spin drying, IPA vapor drying and Marangoni drying, etc. A brief introduction to these drying methods is described below. The spin drying method uses centrifugal force to spin the wafer at high speeds, so as to remove water droplets from the surface of the wafer. In general, the wafer rotational speed must be at least 3500 rpm(revolutions per minute) to ensure a complete removal of the droplets from the surface of the wafer. However, excessive rotational speeds can lead to damage to the electric devices on the wafer, and the wafer rotational speed is usually set to 3000 rpm for the spin drying method according to the prior art. In this case, watermarks may be formed on the wafer and dissolved oxygen in the watermarks may further results in defects on the wafer since the rotational speed is insufficient. Another problem of the spin drying method is the issue of static electricity. During the high-speed spinning process of the wafer, charges may be accumulated on the wafer and may further attract particles in the air, thereby reducing the surface cleanliness of the wafer.

The IPA vapor drying process uses a heater to evaporate an IPA solution, thereby forming the IPA vapor. Following that, the wafer is placed inside the heated vapor of the IPA solution, and condensed IPA replaces the water adhering to the surface of the wafer. The IPA process does avoid charge accumulation on the wafer; however, it is not easy to replace the water droplets from within the trenches and the contact holes on the wafer with the condensed IPA. The Marangoni drying method involves slowly removing the wafer vertically from a washing tank, at a suitable speed and at room temperature, then using a nitride gas and an IPA vapor to blow dry the wafer. When the wafer is exiting from the top surface of the water, a bent region is formed between the wafer and a meniscus between gas and liquid, into which the IPA vapor dissolves. This reduces the surface tension of the water, preventing the wafer from dripping water. The advantage of the Marangoni drying method is that it uses less IPA solution. But it is still difficult to take off the water droplets from within the trenches and the contact holes on the wafer.

Since the spin drying method is limited to rotational speed, wafer surface profile and static electricity, and has the problems such as the occurrence of the watermarks and the absorption to the particles, it is not suitable at all for being employed in some advanced semiconductor processes such as 0.18-micro or 0.15-micro processes. In addition, both of the IPA vapor drying method and the Marangoni drying method have the disadvantages of being difficult to replace the water droplets from within the trenches and the contact holes on the wafer. Therefore, it is necessary to lengthen the contact time of the wafer, the pure water etc. with the IPA vapor to cause a great consumption of the IPA vapor for both of the IPA vapor drying method and the Marangoni drying method to remove the water droplets from the wafer. In order to improve the yield of the semiconductor manufacturing processes, and also to avoid environmental pollution from organic contaminants produced by the IPA vapor, a more effective drying process must be developed to reduce the environmental impact.

### SUMMARY OF INVENTION

It is therefore an object of the claimed invention to provide a drying process for wafers, so as to solve the problems mentioned above.

According to the claimed invention, the drying process for wafers comprises positioning the wafers to be dried in a cleaning device full of IPA vapor and replacing moisture out of the wafers with the IPA vapor. Gas steam including the IPA vapor is exhausted from the cleaning device into a scrubber, and the scrubber has at least a solvent therein for dissolving the IPA vapor and an exhaust outlet for discharging gas mixture of the IPA vapor and the solvent. A flow rate of the solvent in the scrubber is adjusted to increase a concentration of the IPA vapor in the cleaning device and thus obtain better uniformity for drying the wafers.

It is an advantage of the present invention that the amount of the dissolved IPA vapor in the scrubber increases with the increase of the flow rate of the solvent for dissolving the IPA vapor. As a result, the concentration of the IPA vapor exhausted from the exhaust outlet of the scrubber is accordingly reduced, and the exhaust rate of the IPA vapor from the exhaust outlet of the cleaning device to the scrubber is also reduced. Since the present invention method can lengthen the contact time of the IPA vapor with the wafer surfaces in the situation of not increasing the consumption of the IPA vapor, better uniformity and drying efficiency can be accomplished and problems such as resistance defects on the wafers and environmental impacts from organic contaminants produced by the IPA vapor can also be reduced.

These and other objects of the claimed invention will be apparent to those of ordinary skill in the art after reading the following detailed description of the preferred embodiment that is illustrated in the various figures and drawings.

### BRIEF DESCRIPTION OF DRAWINGS

FIGS. 1 is a schematic diagram of an apparatus for drying wafers according to the present invention; and

FIGS. 2-4 are schematic diagrams of a resistance distribution on a dried wafer according to the present invention.

### DETAILED DESCRIPTION

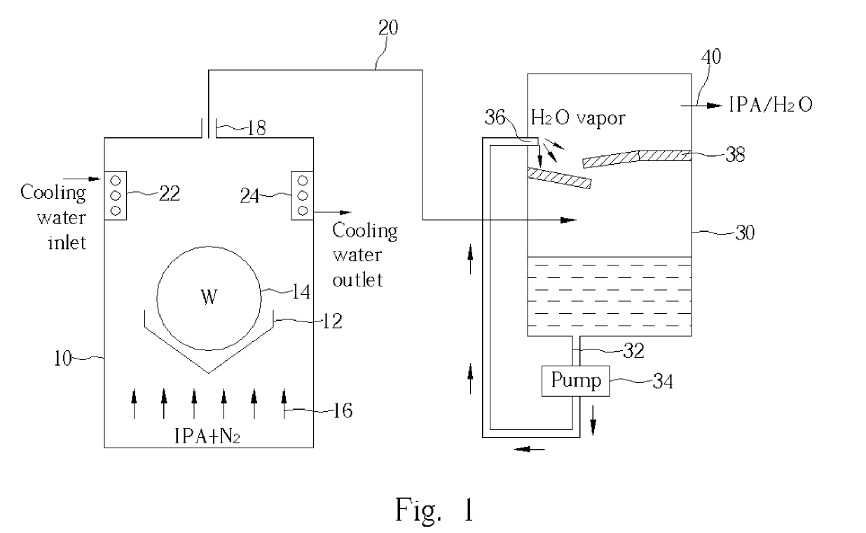

Referring to FIG. 1, FIGS. 1 is a schematic diagram of an apparatus for drying wafers according to the present invention. As shown in FIG. 1, a cleaning device 10 includes a wafer holder 12 for holding a plurality of wafers 14 to be dried. The surfaces of the wafers 14 have an uneven profile; for example, the wafers 14 may contain a plurality of holes thereon. These holes can be used as via holes or contact holes according to the function thereof. The drying process of the present invention can be part of the cleaning process performed after the photolithographic and etching processes for forming these holes. In addition, the drying process of the present invention may also be part of any cleaning process performed in the semiconductor manufacturing processes.

The cleaning device 10 is full of IPA vapor. Selectively, nitrogen or other inert gases may be injected into the cleaning device 10, so as to reduce a partial pressure of the oxygen in the cleaning device 10 and reduce a concentration of the dissolved oxygen in the residual water on the wafers 14. As indicated by an arrow 16 shown in FIG. 1, the drying gases including the IPA vapor and nitrogen blow from a heater (not shown) positioned at the bottom of the cleaning device 10 toward the wafers 14. Generally, a surface temperature on the wafers 14 is about at room temperature, and thus the heated IPA vapor is condensed on the surfaces of the wafers 14 to mix with the residual water into IPA/water droplets. The IPA/water droplets are supposed to fall downward and to be collected by a collector (not shown) positioned at the bottom of the cleaning device 10. In order to improve the drying efficiency on the wafers 14, a cooling fluid pipe including the cooling water inlet 22 and the cooling water outlet 24 is positioned at the top of the cleaning device 10. The cooling fluid can be used to adjust the temperature of the IPA vapor and condense the IPA vapor onto the wafers 14.

It is possible that the IPA/water droplets are heated into vapor again before they fall onto the collector. As a result, the concentration of the water vapor is increased and the concentration of the IPA vapor is accordingly reduced in the cleaning device 10, so as to reduce the wafer drying efficiency by the IPA vapor. In order to prevent this situation, an exhaust outlet 18 of the cleaning device 10 is positioned above the wafers 14 to exhaust gas steam 20 including the IPA vapor and the water vapor from the cleaning device 10 and to maintain a sufficient concentration of the fresh IPA vapor in the cleaning device 10 to dry the wafers 14. The gas steam 20 is exhausted from the exhaust outlet 18 of the cleaning device 10 to a scrubber 30 to be treated and discharged into the atmosphere.

Still as shown in FIG. 1, the scrubber 30 contains at least a solvent for dissolving the IPA vapor, and an exhaust outlet 40 for discharging gas mixture of the IPA vapor and the solvent for dissolving the IPA vapor. Water is preferred to be the solvent to dissolve the IPA vapor and reduce the environmental impact. Devices such as a fluid pipe 32 and a pump 34 are used to drain the water from the bottom of the scrubber 30 and inject the water back to the top of the scrubber 30, so as to increase a dissolving efficiency of the water vapor 36 to the IPA vapor, and reduce a concentration of the IPA vapor to be discharged from the exhaust outlet 40. In a better embodiment of the present invention, the scrubber 30 further includes a plurality of screens 38 for obstructing the exhaust of the IPA vapor and increasing the contact time of the water vapor 36 and the IPA vapor before they are discharged out.

The most important feature of the present invention is that the water flow rate in the scrubber 30 can be adjusted to improve the wafer uniformity in the cleaning device 10. With an increase of the water flow rate, the amount of the IPA vapor dissolved in the scrubber 30 is also increased. If the IPA/H₂O gas mixture is discharged at a constant rate from the exhaust outlet 40, the concentration of the IPA vapor to be discharged from the exhaust outlet 40 is deduced when the water flow rate is increased. Accordingly, the amount of the IPA vapor exhausted from the exhaust outlet 18 of the cleaning device 10 should be reduced when the amount of the IPA vapor exhausted from the scrubber 30 is reduced. Since the present invention method can lengthen the contact time of the IPA vapor with the wafer surfaces in the situation of not increasing the consumption of the IPA vapor, better uniformity and drying efficiency can be accomplished, and problems such as resistance defects on the wafers and environmental impacts from organic contaminants produced by the IPA vapor can also be reduced. In a better embodiment of the present invention, the water flow rate is suggested to between 5 L/min and 10 L/min, and a saturation steam pressure of the IPA vapor is suggested to be 33 mmHg.

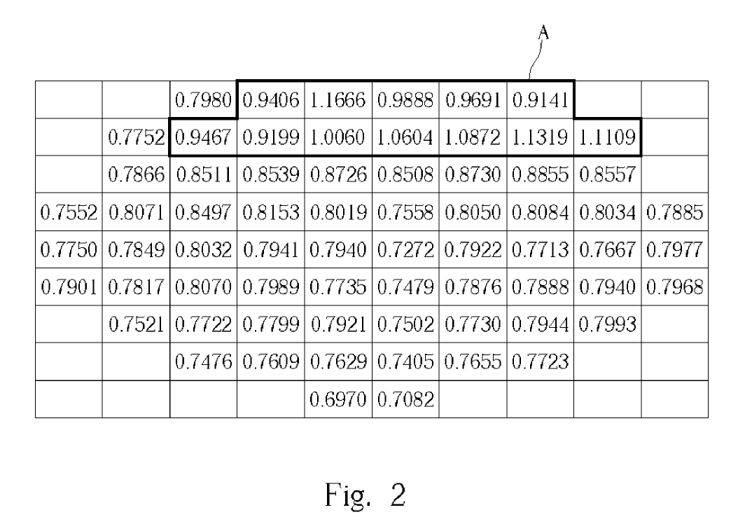

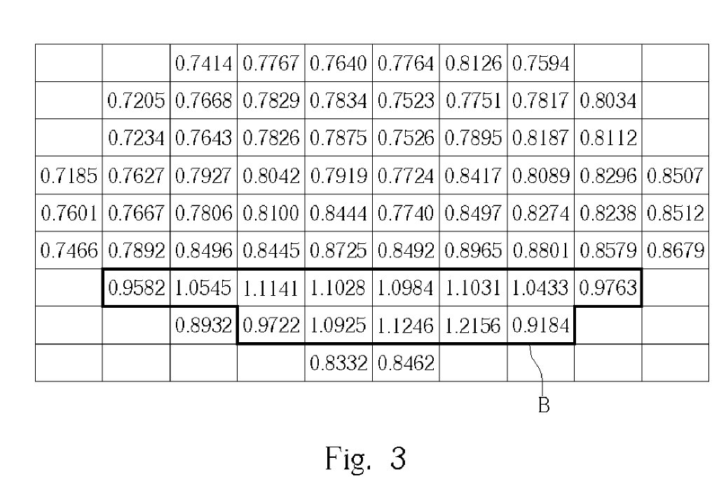

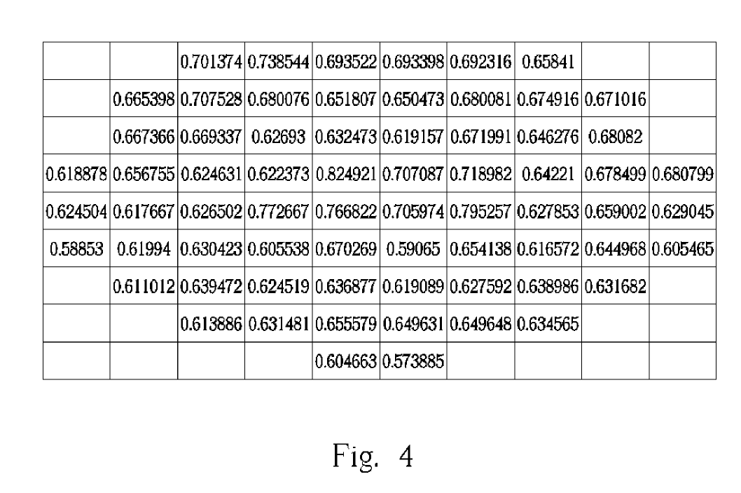

FIGS. 2-4 are schematic diagrams of a resistance distribution on a dried wafer according to the present invention. The resistance distributions shown in FIGS. 2-4 are capable of showing the improvement in the wafer drying uniformity by adjusting the water flow rate in the scrubber. However, the present invention is not limited to improve the resistance, other wafer defects resulted from low drying uniformity of wafers can also be improved according to the present invention. The data shown in FIG. 2 and FIG. 3 refer to capacitor resistance (R_{C}) at via holes on the wafer, and they are measured from an upright wafer and a reverse wafer, respectively, positioned in the cleaning device 10 with a water flow rate of less than 3 L/min in the scrubber 30, as being shown in FIG. 1. From the data shown in FIG. 2 and FIG. 3, it is obvious that high resistance regions A and B are located at the top position of the cleaning device 10 and adjacent to the exhaust outlet 18. In addition, the data shown in FIG. 4 refer to capacitor resistance (R_{C}) at via holes on the wafer, and they are measured from an upright wafer positioned in the cleaning device 10 with a water flow rate of ranging between 5 L/min and 10 L/min in the scrubber 30, as being shown in FIG. 1. In comparison with the resistance distributions shown in FIGS. 2 and 3, the high resistance regions disappear and a more uniform resistance distribution is accomplished in FIG. 4 by increasing the water flow rate in the scrubber.

The exhaust rate of the IPA vapor from the cleaning device is reduced to increase the amount of the IPA vapor in the cleaning device according to the present invention. Therefore, the present invention has the advantages of lengthening the contact time of the IPA vapor with the wafer surfaces to obtain better uniformity and drying efficiency in the situation of not increasing the consumption of the IPA vapor. In addition to the method of adjusting the water flow rate as mentioned above, the present invention may also adjust a partial pressure or an evaporation rate of the IPA vapor to control the exhaust rate of the IPA vapor from the cleaning device. For example, a pressure or a temperature in the cleaning device can be adjusted, or a partial pressure of other drying gases filling in the cleaning device can also be adjusted to accomplish the advantages of the present invention.

In contrast to the prior art, the drying process lengthens the contact time of the IPA vapor with the wafer surfaces in the situation of not increasing the consumption of the IPA vapor according to the present invention. As a result, better uniformity and drying efficiency can be accomplished, and problems such as resistance defects on the wafers and environmental impacts from organic contaminants produced by the IPA vapor can also be reduced.

Those skilled in the art will readily observe that numerous modifications and alterations of the method may be made while retaining the teachings of the invention. Accordingly, the above disclosure should be construed as limited only by the metes and bounds of the appended claims.

1. A drying process for wafers, the drying process comprising:
positioning the wafers to be dried in a cleaning device full of IPA vapor and replacing moisture out of the wafers with the IPA vapor;
exhausting gas steam including the IPA vapor from the cleaning device into a scrubber, the scrubber comprising at least a solvent for dissolving the IPA vapor and an exhaust outlet for discharging gas mixture of the IPA vapor and the solvent for dissolving the IPA vapor; and
adjusting a flow rate of the solvent in the scrubber to increase a concentration of the IPA vapor in the cleaning device and thus obtain good uniformity for drying the wafers.

2. The drying process of claim 1 wherein surfaces of the wafers comprise an uneven profile.

3. The drying process of claim 1 wherein the wafers comprise a plurality of holes thereon.

4. The drying process of claim 3 wherein the holes comprise via holes or contact holes.

5. The drying process of claim 1 wherein the solvent comprises water.

6. The drying process of claim 5 wherein the flow rate of the solvent ranges between 5 L/min and 10 L/min.

7. The drying process of claim 1 wherein the cleaning device comprises nitrogen.

8. A drying process for wafers, the drying process comprising:
positioning the wafers to be dried in a cleaning device full of IPA vapor and replacing moisture out of the wafers with the IPA vapor; and
reducing an exhaust rate of the IPA vapor from the cleaning device to increase a concentration of the IPA vapor in the cleaning device and thus obtain good uniformity for drying the wafers.

9. The drying process of claim 8 further comprising exhausting gas steam including the IPA vapor from the cleaning device into a scrubber, the scrubber comprising at least a solvent for dissolving the IPA vapor and an exhaust outlet for discharging gas mixture of the IPA vapor and the solvent for dissolving the IPA vapor.

10. The drying process of claim 9 further comprising adjusting a flow rate of the solvent in the scrubber to reduce the exhaust rate of the IPA vapor from the cleaning device.

11. The drying process of claim 10 wherein the solvent comprises water.

12. The drying process of claim 11 wherein the flow rate of the solvent ranges between 5 L/min and 10 L/min.

13. The drying process of claim 8 wherein the cleaning device comprises nitrogen.

14. The drying process of claim 8 further comprising adjusting a partial pressure of the IPA vapor to reduce the exhaust rate of the IPA vapor from the cleaning device.

15. The drying process of claim 8 further comprising adjusting an evaporation rate of the IPA vapor to reduce the exhaust rate of the IPA vapor from the cleaning device.

16. The drying process of claim 8 wherein surfaces of the wafers comprise an uneven profile.

17. The drying process of claim 8 wherein the wafers comprise a plurality of holes thereon.

18. The drying process of claim 17 wherein the holes comprise via holes or contact holes.
